(19) United States
(12) Patent Application Publication
(10) Pub. No.: US 2004/0182162 A1
(43) Pub. Date: Sep. 23, 2004

(54) Apparatus for the transmitting of electrical signals

(75) Inventor: Urs Moser, Zurich (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Markets and Technology AG, Winterthur (CH)

(21) Appl. No.: 10/769,617

(22) Filed: Jan. 29, 2004

(30) Foreign Application Priority Data
Feb. 3, 2003 (EP) 03405050.0

(51) Int. Cl. G01N 29/24

(52) U.S. Cl. 73/661

(57) ABSTRACT

An apparatus for the transmitting of electrical signals and electrical energy for an ultrasonic measuring system with rotatable or swivellable transducer elements includes a housing (31) and a shaft (32), which is rotatably or swivellably arranged relative to the housing. The apparatus additionally includes two coils (36.2, 36.2) and also two halves (35.1, 35.2) of a shell-type core (35), wherein the one coil (36.1) is secured on the housing, and the other coil (36.2) to the shaft (32), and wherein the two coils (36.1, 36.2) and the two shell-type core halves (35.1, 35.2) together form an inductive transmitter.

The invention relates to an apparatus for the transmitting of electrical signals and/or electrical energy for a system with one or more rotatable or swivellable components in accordance with the preamble of claim 1, to the use of an apparatus of this kind and also to a system with an apparatus of this kind.

In a system with one or a plurality of rotatable or swivellable components, in particular in an ultrasonic measuring system with rotatable or swivellable transducer elements, as described for example in the document EP 0 926 491 A1, there is the problem that electrical signals have to be transmitted between one or more components of generally fixed locatation, in the named example between the control and supply apparatus and the data processing unit and the rotatable or swivellable components, in the named example the transducer elements. It is mentioned in the document EP 0926 491 A1 that the transmitting of signals can take place via slip contacts such as slip rings or other suitable communication means, for example contact-free couplers such as optoelectronic, electromagnetic or inductive couplers. The mentioned possibilities for the transmitting of signals are however partly associated with considerable disadvantages. For example, when using slip rings the possible speed of rotation, or the frequency of swivelling, is limited due to the heating effect and wear occurring when at higher speeds of rotation or swivelling frequencies. Furthermore, the contact noise of the slip rings causes disturbance during the transmitting of weak signals, such as non-amplified received signals.

The rather large dimensions of high quality slip rings and the expensive manufacturing costs of the precision parts are also negative points.

As explained above, the named document also discloses contact-free couplers for the transmitting of electrical signals. Unfortunately the disclosure is essentially limited to the mention of the transmitting principle. A description or illustration of a concrete embodiment of a coupler or an apparatus for the transmitting of electrical signals and/or electrical energy is however lacking in the named document.

The object of the invention is to make available an apparatus for the transmitting of electrical signals and/or electrical energy in a system with one or a plurality of rotatable or swivellable components, which facilitates a high speed of rotation or pivotal frequencies, works in a contact-free manner, at least so far as the transmitting of signals and energy is concerned, which has relatively compact dimensions and can be manufactured economically. A further object of the present invention is to make available a method, the subject of which is the use of an apparatus of this kind, and also a system with one or a plurality of rotatable or swivellable components which includes an apparatus of this kind.

This object is solved in accordance with the invention by the apparatus defined in claim 1 and by the method defined in claim 7, as well as by the system defined in claim 8.

The apparatus in accordance with the invention for the transmitting of electrical signals and/or electrical energy for a system with one or a plurality of rotatable or swivellable components, for example for an ultrasonic measuring system with rotatable or swivellable transducer elements, includes two parts, which are rotatable or swivellable relative to one another, in particular a housing and a shaft, which is a arranged in a rotatable or swivellable manner relative to the housing. The apparatus additionally includes at least two electromagnetic coupling elements, in particular coils, wherein the one coupling element is secured to the first of the two parts, and the other coupling element to the second of the two parts, and wherein the two coupling elements are arranged in such a way that electromagnetic energy can be transmitted between the coupling elements, in particular that energy can be transmitted inductively.

In a preferred embodiment the apparatus includes more than two electromagnetic coupling elements, which are arranged in pairs, wherein one coupling element of a pair of coupling elements is respectively secured to the first part and the other coupling element of a coupling element pair is secured to the second part and wherein the coupling elements are arranged in such a way that electromagnetic energy can be transmitted between the coupling elements of a coupling element pair.

The apparatus additionally preferably includes at least one magnetic core, in particular a soft magnetic core, as for example a core of ferrite material, which is formed and arranged in such a way that the inductive coupling between two coupling elements of a coupling element pair is enhanced. In a variant the at least one core has an outer contour which is formed as a hollow body closed on one side. Preferably the at least one core includes an inner part, which is either solid or tubular. In a preferred variant the inner part is arranged in the interior of the hollow body and connected with this, wherein the outer diameter of the inner part is smaller than the inner diameter of the hollow body.

In a further preferred embodiment, the apparatus includes one magnetic, preferably soft magnetic core per coupling pair, in particular a shell-type core, or a plurality of magnetic, preferably soft magnetic core parts, in particular two halves of a shell-type core, wherein the cores or core parts are designed and arranged in such a way that the inductive coupling between the coupling elements of a coupling element pair is enhanced and/or that the coupling between two coupling elements of different coupling element pairs is weakened.

The coupling elements of a coupling element pair are preferably respectively separated from each other by an air gap. The core parts of a coupling element pair are preferably respectively separated from each other by an air gap.

The coupling elements and/or the cores or rather core parts are preferably arranged coaxially with respect to one of the parts, in particular with respect to a shaft of the apparatus.

The invention also includes the use of the apparatus in accordance with the invention and its preferred embodiments in a system with one or a plurality of rotatable or swivellable components, in particular in an ultrasonic measuring system with rotatable or swivellable transducer elements.

Further the invention includes a system with one or more rotatable or swivellable components, in particular an ultrasonic measuring system with pivotable or swivellable transducer elements and with an apparatus in accordance with the invention for transmitting electrical signals and/or electrical energy, in particular with one of the embodiments of an apparatus of this kind as described above.

In a preferred embodiment, the system includes a measuring probe with rotatable or swivellable transducer elements and an apparatus in accordance with the invention for transmitting electrical signals and/or electrical energy, in particular one of the above-described embodiments of an invention of such an apparatus, and also a shaft, preferably a flexible shaft, by means of which the transducer elements are connected to the apparatus.

In a further preferred embodiment the system includes a combined transmission and drive unit with an apparatus in accordance with the invention for the transmission of electrical signals and/or electrical energy, in particular with one of the embodiments of an apparatus of this kind described above. The combined transmission and drive unit can also be regarded as an independent subject.

The apparatus in accordance with the invention for the transmitting of electrical signals and/or electrical energy has the advantage that the transmitting of signals and energy takes place in contact-free manner and thus without wear, apart from the journalling of the shaft. Thus a disturbance-free signal transmission is possible even at high speeds of rotation, for example at 1000 revolutions per minute and above. The apparatus in accordance with the invention is suitable for bidirectional transmission and has a high dynamic range. Thus for example transmitting signals of 10 W, corresponding to 20 V, can be transmitted in one direction and in the opposite direction receiver signals of 1 μV. The small amount of noise which is achieved on passive transmission of the signals is also advantageous, as well as the comparatively high bandwidth of the signal transmission, which typically lies in the region of 1 to 10 MHz. Further advantages of the apparatus in accordance with the invention are the relatively small dimensions and the manufacture without expensive precision parts.

In a preferred embodiment the apparatus includes more than two coupling elements for the transmission of electrical signals and/or electrical energy, for example 4, 6, 8, 10 or more coupling elements, in particular 16 or 18 coupling elements, which are arranged in pairs, wherein each coupling element pair forms a transmitter. Thus it is possible to transmit a plurality of channels and in particular high frequency channels in parallel, in a simple manner.

Further advantageous embodiments are based on the dependent claims and the drawing.

The invention is explained in the following on the basis of the embodiments and the drawing. They show:

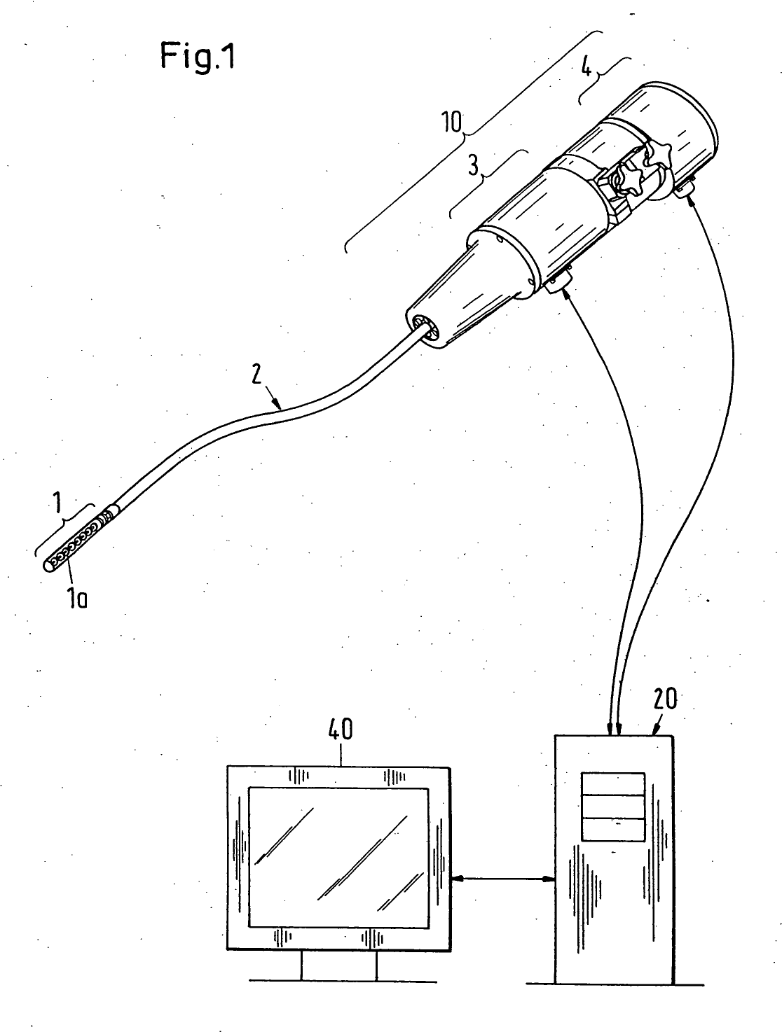

FIG. 1 an embodiment of a system with rotatable or swivellable components, in which an apparatus in accordance with the present invention is used,

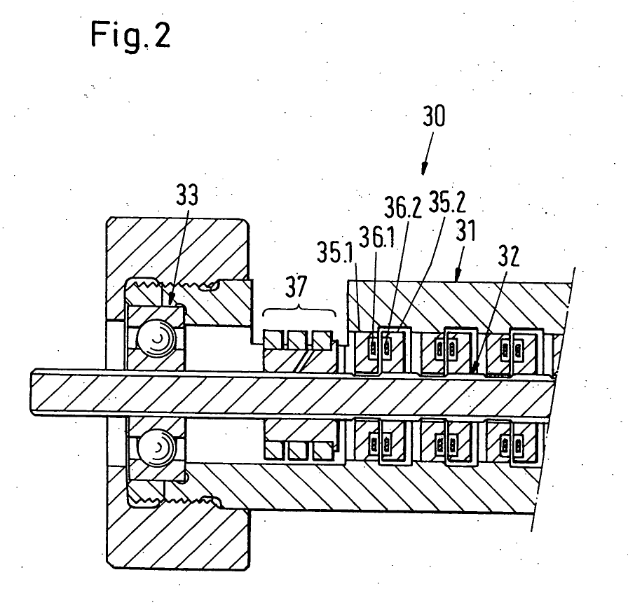

FIG. 2 a longitudinal section through an embodiment of an appara tus in accordance with the present invention, and

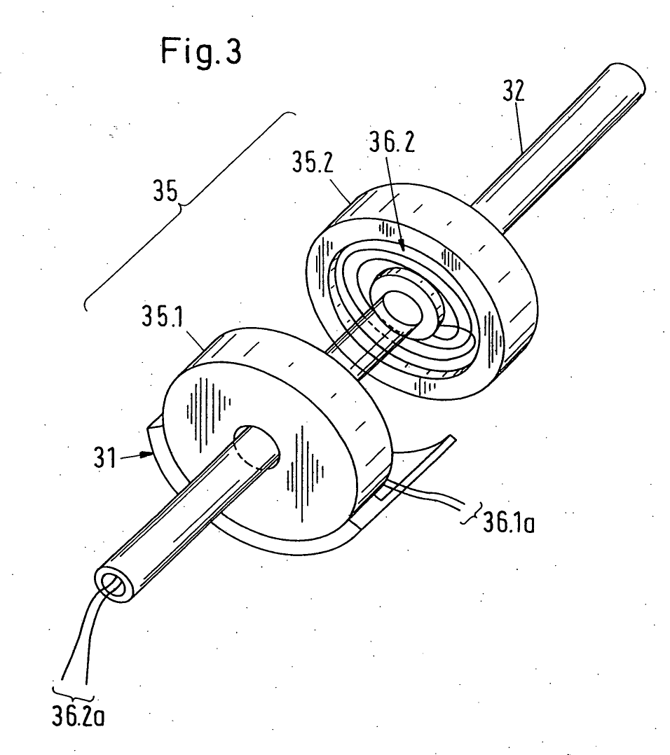

FIG. 3 a perspective view of a further embodiment of an apparatus in accordance with the present invention.

The embodiment shown in FIG. 1 of a system with rotatable or swivellable components is an ultrasonic measuring system, for example an image generating ultrasonic measuring system for the three dimensional repressentation of parts of the human or animal body. The ultrasonic measuring system includes an ultrasonic measuring probe 1 with rotatable or swivellable transducer elements 1a, a combined transmission and drive unit 10 and a flexible shaft 2, by means of which the ultrasonic measuring probe 1 together with the transducer elements 1a is connected to the transmission and drive unit 10. In the present example the transmission and drive unit 10 contains a transmission part 3 with an apparatus for the transmission of electrical signals and/or electrical energy in accordance with the present invention and a drive part 4 with a drive apparatus, such as for example an electric motor, which drives the rotating or swivellable movements of the transducer elements 1a via the flexible shaft 2. The transducer elements 1a are connected via electrical connection leads, which are arranged within the flexible shaft 2, to the apparatus for transmitting electrical signals and/or electrical energy, which is referred to briefly in the following as transmitting apparatus, by means of which electrical signals and/or electrical energy are transmitted, in the operating state, between rotating or swivellable and not non-rotating or swivellable components of the system. During a measurement, the speed of rotation of the transducer elements typically lies at 1,000 to 3,000 rotations per minute.

The ultrasonic measuring system shown further includes a display unit 40 and a control, supply and data processing unit 20, which is not only connected to the display unit 40 but also to the transmission and drive unit 10 or rather the transmission and drive apparatus, for example via cable and plug connections. In the present example the control, supply and data processing unit 20 serves to control the drive apparatus, to make available transmission signals for the transducer elements 1a and to detect the receiver signals delivered by the transducer elements and to process them in such a manner that they can be displayed as a picture via the display unit 40.

FIG. 2 shows a longitudinal section of an embodiment of an apparatus for transmitting electrical signals and/or electrical energy in accordance with the present invention. The apparatus 30 includes a housing 31 and a shaft 32, which is arranged rotatably or swivellably in the housing by means of one or a plurality of bearings 33. In the present embodiment the housing 31 is tubular and the shaft 32 is arranged concentrically in the housing 31. The apparatus 30 additionally includes one or a plurality of pairs of coils 36.1, 36.2 and a core or a plurality of core parts per coil pair, preferably a shell-type core, which advantageously consists of two cylinder-shaped halves 35.1, 35.2 with annular recesses, wherein the halves are arranged in such a way that the recesses stand opposite each other and that an air gap is present between the halves of typically 0.2 to 0.5 mm. The shell-type cores or rather their halves are advantageously made of a soft-magnetic material, for example a ferrite material such as a MnZn-ferrite for example. In the embodiment a coil of a coil pair 36.1, 36.2, is arranged in one of the recesses of the two halves 35.1, 35.2 of a shell-type core standing opposite one another and fixedly connected with the respective half. The coils 36.1, 36.2 are made, for example, from a few turns of an insulated copper wire. The halves are each provided with an aperture in the axial direction and are arranged concentrically on the shaft 32, with the one half 35.2 being secured to the shaft 32 and the other half 35.1 being secured to the housing 31 and with the shaft 32 being formed in such a way that it is freely rotatable and/or swivellable in the aperture of the half secured on the housing.

The two coils of a pair of coils 36.1, 36.2 form a high frequency transmitter together with the two halves (35.1, 35.2) of a shell-type core, by means of which high frequency signals and electrical energy can be transmitted between the side 35.1, 36.1 of the high frequency transmitter which is mechanically connected to the housing 31 and the side 35.2, 36.2 which is connected to the shaft 32. The high frequency transmitter described in the present embodiment is broadband with a typical bandwidth of 10 MHz and higher and facilitates bidirectional transmission, i.e. not only radio signals can be transmitted to a rotatable or swivellable transducer for example, but also reception signals from this transducer. The two halves (35.1, 35.2) of a shell-type core form a closed magnetic circuit, which displays low losses and which is largely insensitive to stray fields, in particular to stray fields of neighbouring transmitters. As a passive component the described high frequency transmitter has low intrinsic noise, which permits a high dynamic range of the transmitted signals. A plurality of high frequency transmitters (radio transmitters) of the described kind are advantageously arranged next to each other, so that a corresponding number of high frequency channels can be transmitted parallel to one another in a simple manner.

In a variant the apparatus 30 includes, in addition to the coil pairs 36.2, 36.2 and shell-type cores 35.1, 35.2, one or more slip rings 37, which are arranged on the shaft 32. By means of the slip rings 37, auxiliary voltages, such as for example direct voltages, and slowly changing auxiliary signals, such as for example voltages or currents of a temperature sensor, can be transmitted directly without being transformed first. The simultaneous transmission of high frequency signals by means of an apparatus in accordance with the invention and of direct voltages and slowly changing auxiliary signals by means of slip rings is interesting economically.

FIG. 3 shows a further embodiment of an apparatus in accordance with the invention in a perspective view. The apparatus includes a housing 31, which is only schematically illustrated in FIG. 3 and a shaft 32, which is arranged in the housing in a rotatable or swivellable manner. Additionally the apparatus includes two coils 36.1, 36.2, only one of which is visible in FIG. 3, and a shell-type core 35 with two cylindrical halves 35.1, 35.2, which are each provided with an annular recess, wherein a coil is respectively arranged and/or secured in each recess and wherein the halves are arranged in such a way that the recesses or rather coils stand opposite each other. The halves are each provided with an aperture in the axial direction and are arranged concentrically on the shaft 32, with the one half 35.2 being secured on the shaft 32 and the other half 35.1 on the housing 31 and with the shaft 32 or the aperture of the half 35.1 secured on the housing being designed in such a way that the shaft 31 is freely rotatable or swivellable. The space between the two halves is enlarged in FIG. 3, i.e. not shown to scale, so that the coil 36.2 is visible in the recess of the half 35.2 connected to the shaft. The air gap between the halves 35.1, 35.2 typically amounts to 0.1 to 1 mm. As described above, the two coils 36.1, 36.2 form a high frequency transmitter together with the two halves 35.1, 35.2 of the shell-type core 35.

In a preferred variant the connections 36. 1a of the coil 36.1 which is not visible in FIG. 3, which is arranged in the half 35.1 connected to the housing 31, are led to the outside via the housing, while the connections 36.2a of the coil 36.2, which is secured in the half 35.2 connected to shaft, are guided in the interior of the shaft 32 via a concentric bore. In a further preferred embodiment, which is not illustrated in FIG. 3, the connections 36.2a of the coil 36.2, which is secured in the half connected with the shaft, are guided in the shaft 32 by means of grooves.

1. Apparatus for the transmitting of electrical signals and/or electrical energy for a system with one or more of rotatable or swivellable components, in particular for an ultrasonic measuring system with rotatable or swivellable transducer elements (1a), said apparatus (30) including two parts (31, 32), which are rotatable or swivellable relative to one another, in particular a housing and a shaft, which is arranged in a rotable or swivellable manner relative to the housing, characterised in that,
the apparatus (30) has additionally at least two electromagnetic coupling elements (36.1.36.2), in particular coils, wherein the one coupling element (36.1) is secured to the first of the said parts (31, 32) and the other coupling element (36.2) to the second one, and wherein the two coupling elements (36.1, 36.2) are arranged in such a way that electromagnetic energy can be transmitted between the coupling elements.

2. Apparatus in accordance with claim 1, wherein the apparatus (30) includes more than two electromagnetic coupling elements (36.1, 36.2), which are arranged in pairs, wherein the one coupling element (36.1) of a coupling element pair is in each case secured to the first part (31) and the other coupling element (36.2) of a coupling element pair is secured to the second part (32) and wherein the coupling elements (36.1, 36.2) are arranged in such a way that electromagnetic energy can be transmitted between the coupling elements of a coupling element pair.

3. Apparatus in accordance with one of the claims 1 or 2 including additionally at least a magnetic core (35, 35.1, 35.2), in particular a soft magnetic core of ferrite material, which is formed and arranged in such a way that the inductive coupling between two coupling elements (36.1, 36.2) of a coupling element pair is enhanced.

4. An apparatus in accordance with claim 3 including a magnetic core (35) per coupling element pair, in particular a soft magnetic shell-type core, or a plurality of magnetic core parts (35.1, 35.2), in particular two halves of a soft magnetic shell-type core, wherein the cores or core parts are formed and arranged in such a way that the inductive coupling between two coupling elements (36.1, 36.2), which belong to the same coupling element pair, is enhanced and/or that the coupling between two coupling elements of different coupling element pairs is weakened.

5. An apparatus in accordance with one of the previous claims, wherein the coupling elements (36.1, 36.2) of a coupling element pair are respectively separated from each other by an air gap, and/or wherein the core parts (35.1, 35.2) of a coupling element pair are respectively separated from one another by an air gap.

6. An apparatus in accordance with one of the previous claims, wherein the coupling elements (36.1, 36.2) and/or the cores (35) or core parts (35.1, 35.2) are arranged coaxially with respect to one of the parts (31, 32), in particular with respect to a shaft of the apparatus (30).

7. The use of an apparatus in accordance with one of the claims 1 to 6 in a system with one or a plurality of rotable or swivellable components, in particular in an ultrasonic measuring system with rotatable or swivellable transducer elements (1a).

8. A system with one or more rotable or swivellable components, in particular an ultrasonic measuring system with rotatable or swivellable transducer elements (1a), said system including an apparatus (30) for transmitting electrical signals and/or electrical energy in accordance with one of the claims 1 to 6.

9. A system in accordance with claim 8 with a measuring apparatus, which includes a measuring probe (1) with rotatable or swivellable transducer elements (1a), a shaft (2), in particular a flexible shaft, and an apparatus (30) for transmitting electrical signals and/or electrical energy in accordance with one of the claims 1 to 6.

10. A system in accordance with one of the claims 8 or 9 including a combined transmission and drive unit (10) with an apparatus (30) for the transmission of electrical signals and/or electrical energy in accordance with one of the claims 1 to 6.
